(19) United States
(12) Patent Application Publication
(10) Pub. No.: US 2025/0082454 A1
(43) Pub. Date: Mar. 13, 2025

(54) MODULAR SYSTEM FOR DELIVERING ANAESTHETIC GAS FOR STUNNING ANIMALS PRIOR TO SLAUGHTER

(71) Applicant: L'Air Liquide, Societe Anonyme pour l'Etude et l’Exploitation des Procedes Georges Claude, Paris (FR)

(72) Inventors: Ansgar RINKLAKE, Krefeld (DE); Marcel BROUNS, Krefeld (DE); Nadia MAYOUFI OUERGHEMMI, Jouy-En-Josas (FR)

(73) Assignee: L'Air Liquide, Societe Anonyme pour l'Etude et l’Exploitation des Procedes Georges Claude, Paris (FR)

(21) Appl. No.: 18/562,245

(22) PCT Filed: May 12, 2022
(86) PCT No.: PCT/EP2022/062882

§ 371 Date: Nov. 17, 2023

(30) Foreign Application Priority Data
May 17, 2021 (DE) DE 102021112741.6

(51) Int. Cl. A61D 7/04

(52) U.S. Cl. CPC A61D 7/04

(57) ABSTRACT

The apparatus of the present invention serves to stun animals prior to slaughter, these being introduced with a gondola into a pit. On a sidewall of the pit is/are designed a gas module, preferably a plurality of gas modules. Each gas module comprises a gas introduction line having a multitude of pores through which an anaesthetic gas can flow laterally into the pit. The multitude of pores ensures a laminar inflow of the anaesthetic gas. The lateral laminar inflow of the anaesthetic gas avoids an increase in the stress of the animals being stunned, thus enabling humane stunning prior to slaughter. At the same time, the modular construction by means of the gas modules facilitates simple dimensioning of the gas introduction capacities required and also the construction and retrofitting of corresponding apparatuses.

### CROSS-REFERENCE TO RELATED APPLICATIONS

This application is a § 371 of International PCT Application PCT/EP2022/062882, filed May 12, 2022, which claims § 119 (a) foreign priority to German patent application DE 10 2021 112 741.6, filed May 17, 2021.

### FIELD OF THE INVENTION

The subject matter of the present invention is a method and an apparatus for stunning animals prior to slaughter, in which the animals are introduced into a pit filled with anaesthetic gas prior to slaughter.

### BACKGROUND

In many countries, animals for slaughter must be stunned prior to slaughter for animal welfare reasons. Particularly in the case of larger animals, such as in particular pigs, a method of stunning is known in which the animals to be stunned are conveyed in a gondola through a pit filled with an anaesthetic gas. It is a disadvantage in this case that the design of the pits makes modification of the gas introduction difficult, especially when a different anaesthetic gas is to be used. In addition, the known systems have shortcomings concerning the infeed and supplementary introduction of anaesthetic gas, which becomes necessary in particular as a result of entrainment losses due to the movement of the gondolas into the pit and out of it.

### SUMMARY OF THE INVENTION

Proceeding from this, the present invention has the object of at least partially overcoming the disadvantages known from the prior art.

This object is achieved by a method and by an apparatus having the features of the independent claims. The respective dependent claims are directed to preferred developments.

The method of the invention for stunning animals prior to slaughter, in which the animals are brought from above in a gondola through an opening into a pit having sidewalls and a floor, in which an anaesthetic gas is introduced into the pit, is characterized in that the anaesthetic gas is introduced through at least one gas module which has a gas introduction line fastened to a support and through which the anaesthetic gas flows, said line having a multitude of pores for introducing the anaesthetic gas into the pit, wherein the support for the at least one gas module is fastened to a sidewall of the pit.

The term “anaesthetic gas” is understood to mean a gas or else gas mixture which in animals brings about a loss of consciousness upon inhalation so that these animals do not consciously experience the slaughtering process. The anaesthetic gas in particular has a density greater than air, so that it remains in the pit purely through the action of gravity. Alternatively, anaesthetic gas has to be continuously introduced as a supplement in order to prevent a drop in the concentration of the anaesthetic gas in the pit, especially a fall below a level that ensures reliable stunning of the animals. In addition, the entry and exit of the gondola(s), which is/are designed as a cage, causes entrainment losses, especially during passage of the gondola(s) through the opening, which are compensated during operation by continuous or discontinuous supplying of anaesthetic gas through the at least one gas module. The support is in particular planar, making the gas introduction line overall planar in design. This enables simple preassembly of the gas module and simple fitting. The support is in particular designed as a planar structure, in particular as a planar grid structure. “Planar” is understood here to mean a design in one plane.

The gas introduction line in particular has a multitude of small openings or pores, in particular stunning lines are used having for example 1000 openings per metre or more, preferably even 3000 openings per metre or more. Anaesthetic gas is fed through these gas introduction lines in a laminar flow. This also reduces the stress of the animals for example compared to a turbulent feed of the anaesthetic gas.

The supply of the anaesthetic gas from the side likewise does not further increase the stress of the animals. The modular construction with one or more gas modules facilitates retrofitting of existing systems and the construction of new systems. The gas modules are preassembled, all that is then needed on site is to fasten the support for the individual gas modules to a sidewall of the pit.

The gas introduction lines of the individual gas modules each have a supply line which can be connected to a central gas supply, preferably in each case via a control valve. The central gas supply provides the anaesthetic gas preferably at a pressure at a level of at least 1.2 bar, preferably at least 1.7 bar, in particular 2.0 bar or more. This causes the pores in the gas introduction line to open, since there is a pressure differential of at least 0.2 bar.

Preferably, the anaesthetic gas used is one of the following gases:
a) 100% argon (Ar);
b) 100% nitrogen (N₂);
c) a mixture of up to 30% by volume carbon dioxide (CO₂), remainder argon (Ar); and
d) a mixture of up to 30% by volume carbon dioxide (CO₂), remainder nitrogen (N₂).

In the case of the pure gases (argon and nitrogen) in particular, the animals are unaware of inhalation of the anaesthetic gas and rapidly become unconscious. This prevents the development of stress in the animals which, is for example triggered by the inhalation of carbon dioxide in high concentrations. At the same time, the infeed of carbon dioxide achieves a narcotic effect since the blood pH decreases. At proportions of up to 30% by volume of carbon dioxide, a narcotic effect is achieved without the animals perceiving the inhalation of carbon dioxide. Gentle stunning of the animals can thus be achieved.

Preferably, the gas flows through the gas introduction line of each gas module with a controllable volume flow. This enables selective control of the concentration of anaesthetic gas in the pit, also for example as a function of the local concentrations of anaesthetic gas at the location of the individual gas module.

Preferably, the design comprises a plurality of gas modules, wherein, during filling of the pit, the gas flows through all gas modules with a predefinable maximum volume flow. This enables a rapid filling of the pit with the anaesthetic gas at the start of the method, so that there is little setup time prior to commencement of stunning and slaughter.

Preferably, the design comprises a plurality of gas modules, wherein, during passage of the gondola through the opening, the gas flows through the at least one gas module designed nearest to the opening with a controllable volume flow. This enables operation of just the gas modules which are designed nearest to the opening, for example the uppermost gas modules, whereas the other gas modules are not operated. This makes it possible to compensate for losses, especially entrainment losses or diffusion losses, at the locations where they arise (at and through the opening), and reduces the consumption of anaesthetic gas.

In a further aspect of the invention, an apparatus is proposed for stunning animals prior to slaughter, in particular according to the method of the invention, comprising a pit into which the animals can be introduced via a gondola through an opening, wherein the pit comprises sidewalls which delimit the opening and a floor formed opposite the opening, wherein the design comprises at least one gas module, which has a gas introduction line that is fastened to a support and has a multitude of pores for delivering the anaesthetic gas, wherein the support for the gas module is fastened to a sidewall of the pit.

Preferably, a volume flow through the gas introduction line of each gas module is individually controllable. This makes it possible to individually control and regulate the individual gas modules.

Preferably, a supply line of each gas module is connected to a central gas supply via a control valve such that control of the respective control valve enables regulation of the volume flow through the gas introduction line of the respective gas module.

Preferably, the apparatus also comprises a control device with which each control valve can be controlled. This allows individual control of the volume flow through the individual gas modules.

Preferably, the apparatus also comprises a control device with which the output rate of a central gas supply can be controlled. This can for example be effected by controlling an evaporator in the central gas supply.

### BRIEF DESCRIPTION OF THE FIGURES

The invention and the associated technical field are elucidated in detail hereinafter with reference to the figures. It should be pointed out that the invention is not intended to be limited by the exemplary embodiments shown. In particular, unless explicitly stated otherwise, it is also possible to extract sub-aspects of the subject matter elucidated in the figures and to combine them with other constituents and knowledge from the present description and/or figures. In particular, it should be pointed out that the figures and especially the size ratios illustrated are merely schematic. Identical reference numerals denote identical articles, such that any elucidations from other figures can be consulted additionally. In the figures:

FIG. 1 shows a first example of an apparatus for stunning animals;

FIG. 2 shows an example of a gas module;

FIG. 3 shows an example of a cross section of a gas introduction line; and

FIG. 4 shows a second example of an apparatus for stunning animals.

### DETAILED DESCRIPTION OF THE INVENTION

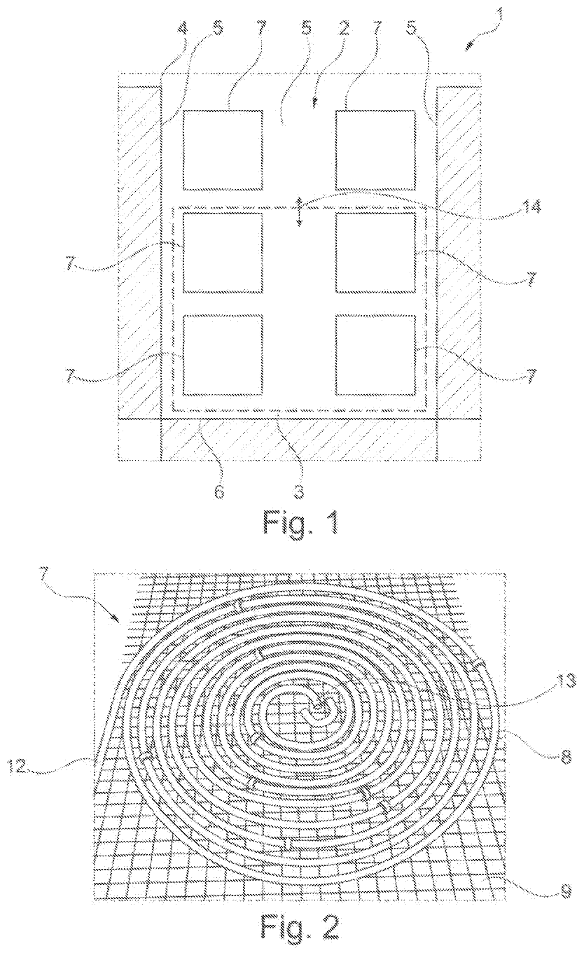

FIG. 1 shows schematically a first example of an apparatus 1 for stunning animals prior to slaughter, comprising a pit 2 into which the animals can be introduced via a gondola 3 through an opening 4, wherein the pit 2 comprises sidewalls 5 which delimit the opening 4 and a floor 6 formed opposite the opening 4 such that the floor 6 is at the bottom in the direction of gravity and the opening 4 is at the top in the direction of gravity. FIG. 1 shows a section through the pit 2 in which three sidewalls 5 are visible. The gondola 3 can—as shown here—be operated as a kind of lift, in which the gondola 3 is passed into the pit 2 from top to bottom, remains in the pit 2 for a defined stunning time and is then drawn back out of the pit 2 from bottom to top. The direction of movement of the gondola 3 is indicated by the arrow 14. Alternatively, the gondola 3 may be part of a paternoster (not shown) having a plurality of gondolas 3 which are moved continuously through the pit 2 such that each gondola 3 remains in the pit 2 for a stunning time. The chosen stunning time must however be sufficiently long that the animals in the gondola 3 lose consciousness and remain unconscious for a predefinable time that enables the slaughter, for example by cutting the throat, of the animals without the respective animal consciously experiencing this. After slaughter, the slaughtered animals are processed, in particular opened and cut up.

In order to enable stunning of the animals, the pit 2 must be filled with an anaesthetic gas. In this case, the only losses that need to be compensated result from the entry and exit of the gondola 3 through the opening 4. These losses are referred to as entrainment losses. In particular, if the anaesthetic gas has a density lower than or equal to the density of the surrounding air, further losses are incurred as a result of diffusion. These are particularly relevant when the anaesthetic gas used is nitrogen with optional admixture of carbon dioxide. According to the present invention, gas modules 7 perform both the filling of the pit 2 and the compensation of the losses. The present example shows six gas modules 7.

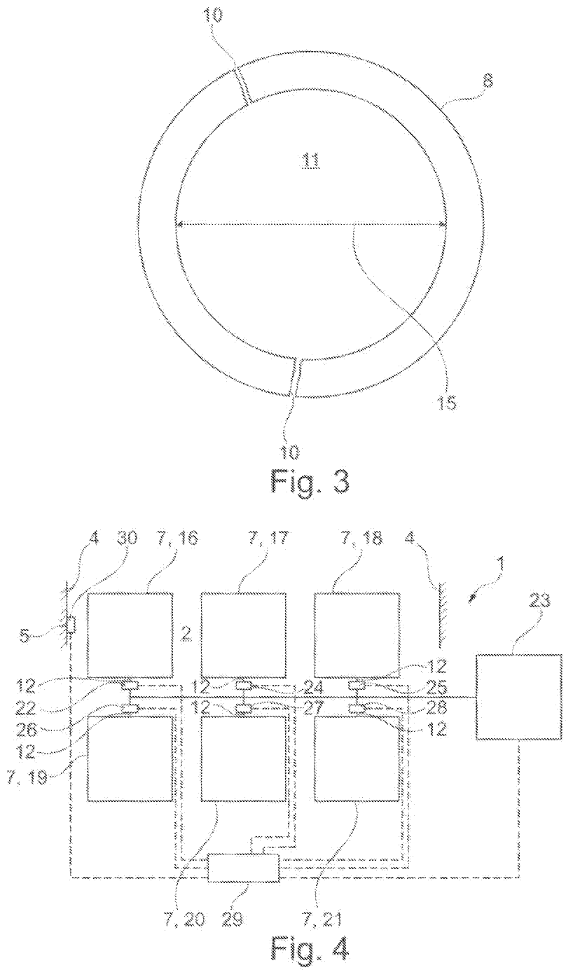

A gas module 7 is shown in detail in FIG. 2 in a perspective view. Each gas module 7 comprises a gas introduction line 8 which is mounted and fixed to a support 9. A gas introduction line 8 is shown in FIG. 3 in cross section. The gas introduction line 8 has a multitude of small openings or pores 10 which connect the interior 11 of the gas introduction line 8 to the outside environment of the gas introduction line 8. The gas introduction line 8 is designed here such that, for example, 1000 pores 10 are formed per linear metre of gas introduction line 8.

The gas introduction line 8 of a gas module 7 has a supply line 12 which—together with the supply lines 12 of any other fitted gas modules 7—is connected to a central gas supply (not shown). Reference in this regard is also made to the discussion below relating to FIG. 4. The end 13 of the gas introduction line 8 is closed, which means that the anaesthetic gas in the interior 11 of the gas introduction line 8 is able to exit the gas introduction line 8 exclusively via the pores 10. If the interior 11 of the central gas supply is then pressurized with the anaesthetic gas, anaesthetic gas will exit from the interior 11 into the pit 2 through the pores. As a result of this, the pit is filled with anaesthetic gas or the concentration of the anaesthetic gas is increased.

The anaesthetic gas used here is preferably argon (100% by volume, impurities excepted), nitrogen (100% by volume, impurities excepted)) or a mixture of up to 30% by volume carbon dioxide, the remainder—except for impurities—being argon or nitrogen. At the same time, argon and nitrogen in particular have the advantage that they do not trigger any suffocation reflex in the animals and therefore reduce the fear felt by the animals during stunning. At the same time, the modular design of the gas supply via gas modules 7 enables simple equipping of the pit 2 or even retrofitting of an existing pit 2 with a gas supply. The structure made up of a stunning line 8 on a support 9 permits simple and rapid fitting of the preassembled gas modules 7, so that retrofitting a pit 2 can proceed rapidly without slaughter downtimes becoming excessive. In the present example, six gas modules 7 are fitted on a sidewall 5 of the pit 2.

As a result of gas modules 7 being fitted on a sidewall 5 (or on a plurality of sidewalls 5) of the pit 2 and the supply through the pores 10 of the gas introduction line 8, the anaesthetic gas is fed laterally into the pit 2 in a laminar flow. When animals are in the pit 2 while the gas module(s) 7 is/are in operation, it has been found that said animals are not additionally frightened by the infeed of the anaesthetic gas in this way, which means that humane stunning of the animals is possible here without increasing the stress of the animals.

In the present example (cf. FIG. 2), the support 9 is designed as a metallic grid structure that is readily fastenable to a sidewall 5 by hanging on hooks or by screw fittings. The gas introduction line 8 can be fastened thereto for example by hose clips or cable ties. The gas introduction line 8 is wound in a spiral in this example. This enables a very uniform exit of the anaesthetic gas from the gas module 7. The stunning line 8 used is preferably a perforated plastic pipe with an internal diameter 15 having a defined throughflow volume per linear metre and per hour. This enables standardization of the gas modules 7 in that these are each designed such that in normal operation a defined number of standard cubic metres of anaesthetic gas per metre length per hour can be introduced into the pit 2 per gas module 7. This enables a simple design of the apparatus 1, since the volume of the pit 2 is known. By designing for a defined number of gas modules 7, it is possible to determine how rapidly the pit 2 can be filled with anaesthetic gas overall and which losses can be compensated.

The pits 2 are usually designed so that there is sufficient space available between the gondola 3 and the sidewalls 5 for the gas modules 7 to be fastened to the sidewall 5 without interfering with the movement of the gondola(s) 3. This facilitates retrofitting of a corresponding pit 2.

FIG. 4 shows a second example of an apparatus 1 for stunning animals. A preferred variant of the gas supply is to be elucidated using this example. The apparatus 1 is illustrated here only in excerpts; components such as the sidewalls 5, the floor 6 and the gondola 3 are omitted from this figure for reasons of clarity. Reference in this regard is made to the disclosure from FIGS. 1 to 3 and the description therein.

In this example, the design likewise comprises six gas modules 7 which are fastened to a sidewall but arranged differently than in the first example. In this second example, the six gas modules 7 are arranged in two rows of in each case three gas modules 7, whereas in the first example they are formed in three rows of in each case two gas modules 7. A first gas module 16, a second gas module 17 and third gas module 18 form a first row which is as close as possible to the opening 4 of the pit 2, while a fourth gas module 19, a fifth gas module 20 and a sixth gas module 21 form a second row which lies beneath the first row of gas modules 16, 17, 18 and hence further away from the opening 4. The first gas module 16 is connected via its supply line 12 and a first control valve 22 to a central gas supply 23. This comprises, for example, a tank for anaesthetic gas in liquefied form having a corresponding evaporator. Likewise, the second gas module 17 is connected via its supply line 12 and a second control valve 24 to the central gas supply 23, while the third gas module 18 is connected via its supply line 12 and a third control valve 25, the fourth gas module 19 is connected via its supply line 12 and a fourth control valve 26, the fifth gas module 20 is connected via its supply line 12 and a fifth control valve 27 and the sixth gas module 21 is connected via its supply line 12 and a sixth control valve 28 to the central gas supply 23. The control valves 22, 24, 25, 26, 27, 28 and the central gas supply 23, in particular an evaporator (not shown) in the central gas supply 23, are connected to a control device 29 via which the flow rate through individual control valves 22, 24, 25, 26, 27, 28 and the output rate of the central gas supply 23 are controlled. The volume flow through the gas introduction lines 8 of each individual gas module 16, 17, 18, 19, 20, 21 can thereby be controlled individually. This makes it possible for the gas to flow through all gas modules 16, 17, 18, 19, 20, 21 at a maximum volume flow, in particular when the pit 2 has to be filled completely with anaesthetic gas at the start and, especially during ongoing operation, for the gas modules 16, 17, 18, 19, 20, 21 to be charged with individual volume flows which are sufficient to compensate for entrainment losses due to the entry and exit of a gondola 3 into/from the pit 2 and possible diffusion losses due to a lower density of the anaesthetic gas compared to the ambient air. Preferably, in this case, only the first gas module 16, the second gas module 17 and the third gas module 18 are charged with individual volume flows of the anaesthetic gas, while the fourth gas module 19, the fifth gas module 20 and the sixth gas module 21 are switched off with no flow passing through them. It is thus preferably possible to compensate for losses such as entrainment and diffusion losses in the vicinity of the opening 4 where they occur.

The apparatus 1 preferably comprises one or more sensors 30 via which the concentration of the anaesthetic gas in the pit 2 can be monitored at one or more locations and used as a control variable for controlling the volume flows through the gas modules 16, 17, 18, 19, 20, 21.

The apparatus 1 of the present invention serves to stun animals prior to slaughter, these being introduced with a gondola 3 into a pit 2. On a sidewall 5 of the pit is/are designed a gas module 7, preferably a plurality of gas modules 7. Each gas module 7 comprises a gas introduction line 8 having a multitude of pores 10 through which an anaesthetic gas can flow laterally into the pit 2. The multitude of pores 10 ensures a laminar inflow of the anaesthetic gas. The lateral laminar inflow of the anaesthetic gas avoids an increase in the stress of the animals being stunned, thus enabling humane stunning prior to slaughter. At the same time, the modular construction by means of the gas modules 7 facilitates simple dimensioning of the gas introduction capacities required and also the construction and retrofitting of corresponding apparatuses 1.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range. Any and all ranges recited herein are inclusive of their endpoints (i.e., x=1 to 4 or x ranges from 1 to 4 includes x=1, x=4, and x=any number in between), irrespective of whether the term “inclusively” is used.

All references identified herein are each hereby incorporated by reference into this application in their entireties, as well as for the specific information for which each is cited.

### REFERENCE NUMERALS

1 apparatus for stunning animals
2 pit
3 gondola
4 opening
5 sidewall
6 floor
7 gas module
8 gas introduction line
9 support
10 pore
11 interior
12 supply line
13 end
14 arrow
15 internal diameter
16 first gas module
17 second gas module
18 third gas module
19 fourth gas module
20 fifth gas module
21 sixth gas module
22 first control valve
23 central gas supply
24 second control valve
25 third control valve
26 fourth control valve
27 fifth control valve
28 sixth control valve
29 control device
30 sensor

1-10. (canceled)

11. A method for stunning animals prior to slaughter, the method comprising the steps of
bring the animals from above in a gondola through an opening into a pit having sidewalls and a floor; and
introducing an anaesthetic gas into the pit, wherein the anaesthetic gas is introduced through at least one gas module which has a gas introduction line fastened to a support and through which the anaesthetic gas flows, wherein the gas introduction line has a multitude of pores for introducing the anaesthetic gas into the pit, wherein the support of the at least one gas module is fastened to a sidewall of the pit.

12. The method of claim 11, wherein the anaesthetic gas used is one of the following gases:
a) 100% argon (Ar);
b) 100% nitrogen (N₂);
c) a mixture of up to 30% by volume carbon dioxide (CO₂), remainder argon (Ar); and
d) a mixture of up to 30% by volume carbon dioxide (CO₂), remainder nitrogen (N₂).

13. The method of claim 11, wherein the gas flows through the gas introduction line of each gas module with a controllable volume flow.

14. The method of claim 11, wherein during filling of the pit, the gas flows through all gas modules with a predefinable maximum volume flow.

15. The method of claim 11, wherein during passage of the gondola through the opening, the gas flows through the at least one gas module designed nearest to the opening with a controllable volume flow.

16. An apparatus for stunning animals prior to slaughter, the apparatus comprising:
a pit into which the animals is introduced via a gondola through an opening, wherein the pit comprises sidewalls which delimit the opening and a floor formed opposite the opening; and
at least one gas module which has a gas introduction line that is fastened to a support and has a multitude of pores for delivering an anaesthetic gas, wherein the support for the gas module is fastened to a sidewall of the pit.

17. The apparatus of claim 16, wherein a volume flow through the gas introduction line of each gas module is individually controllable.

18. The apparatus of claim 16, wherein a supply line of each gas module is connected to a central gas supply via a control valve.

19. The apparatus of claim 18, wherein the control device with which each control valve is controlled.

20. The apparatus of claim 18, wherein the control device with which the output rate of a central gas supply is controlled.
